(19) United States
(12) Patent Application Publication
(10) Pub. No.: US 2002/0096204 A1
(43) Pub. Date: Jul. 25, 2002

(54) Sunshade Device

(76) Inventor: Chen-Hsiung Lin, Taichung (TW)

Correspondence Address: Chen-Hsiung Lin, 58, MA YUAN WEST ST.,, TAICHUNG, TW

(21) Appl. No.: 09/771,042

(22) Filed: Jan. 19, 2001

(51) Int. Cl. A45B 21/00; A45B 19/08; F16D 1/00; F16B 2/02; F16B 7/04

(52) U.S. Cl. 135/25.4; 135/98; 403/109.5; 403/351

(57) ABSTRACT

A sunshade device has a lower hollow shaft, an upper shaft inserted in the lower hollow shaft, a plurality of stretchers connected to the upper shaft, and a sunshade awning disposed on the stretchers. The upper shaft has a lower end cover, a neck bar disposed on a bottom of the lower end cover, and a base disk disposed on a bottom of the neck bar. A first semicircular sleeve and a second semicircular sleeve are inserted in the lower hollow shaft to surround the neck bar.

### BACKGROUND OF THE INVENTION

The present invention relates to a sunshade device. More particularly, the present invention relates to a sunshade device which has an upper shaft to be retraceted or extended.

Referring to FIG. 1, a conventional sunshade device has a shaft 10, a plurality of stretchers 20 connected to the shaft 10, and a sunshade awning 30 disposed on the stretchers 20. However, the shaft 10 cannot be retraceted.

Referring to FIG. 2, another conventional sunshade device has an upper shaft 40, a lower shaft 40′, an upper collar 6 disposed on the lower shaft 40′, a plurality of stretchers 70 connected to the upper shaft 40, and a sunshade awning 80 disposed on the stretchers 70. The upper collar 6 has a round hole 60. The upper shaft 40 has an elastic protrusion 50 for insertion into the round hole 60 of the upper collar 6. The upper shaft 40 can be detached from the lower shaft 40′. When the lower shaft 40′ is lost, the conventional sunshade device is useless.

### SUMMARY OF THE INVENTION

An object of the present invention is to provide a sunshade device which has an upper shaft to be retraceted in a lower hollow shaft gradually.

Accordingly, a sunshade device comprises a lower hollow shaft, an upper shaft inserted in the lower hollow shaft, a plurality of stretchers connected to the upper shaft, and a sunshade awning disposed on the stretchers. The lower hollow shaft has a narrowed neck portion. The upper shaft has a lower end cover, a neck bar disposed on a bottom of the lower end cover, and a base disk disposed on a bottom of the neck bar. A first semicircular sleeve and a second semicircular sleeve are inserted in the lower hollow shaft. The first semicircular sleeve has a first interior, a pair of first protruded blocks, and a first confining portion. The second semicircular sleeve has a second interior, a pair of second protruded blocks, and a second confining portion. The first semicircular sleeve engages with the second semicircular sleeve. The first semicircular sleeve and the second semicircular sleeve surround the neck bar. The neck bar is rotated in the first interior of the first semicircular sleeve and the second interior of the second semicircular sleeve.

### BRIEF DESCRIPTION OF THE DRAWINGS

FIG. 1 is an elevational assembly view of a first conventional sunshade device of the prior art;

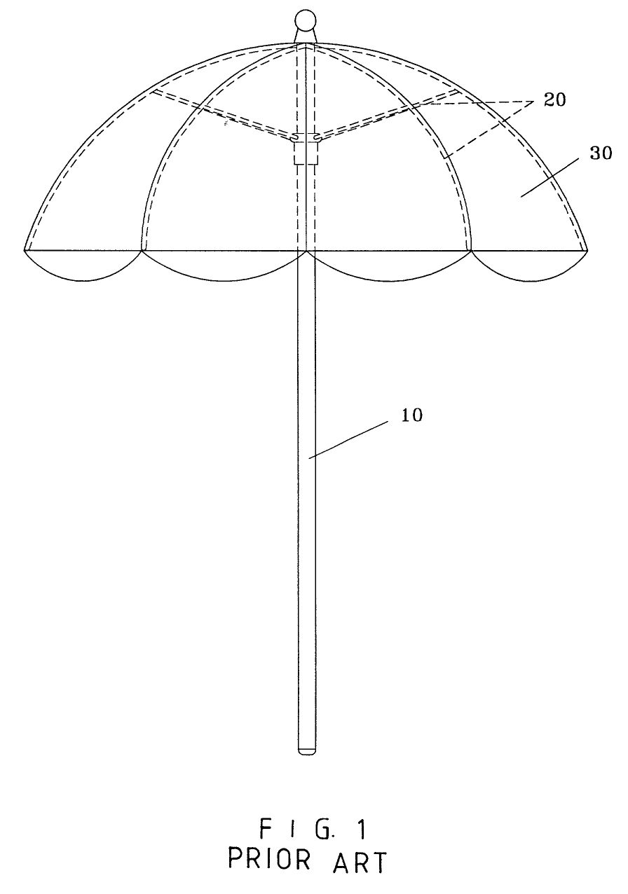

FIG. 2 is an elevational assembly view of a second conventional sunshade device of the prior art;

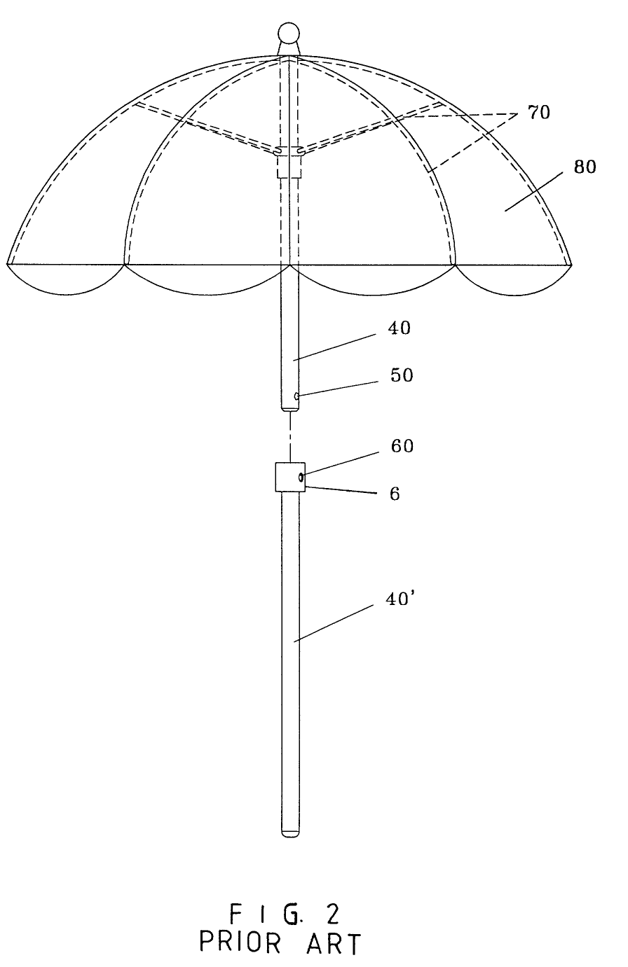

FIG. 3 is an elevational assembly view of a sunshade device of a preferred embodiment in accordance with the present invention;

FIG. 3A is a sectional view of a lower portion of an upper shaft and an upper portion of a lower hollow shaft;

FIG. 4 is a perspective exploded view of a first semicircular sleeve, a second semicircular sleeve, an upper shaft, and a lower hollow shaft of a preferred embodiment in accordance with the present invention;

FIG. 5 is a schematic view illustrating a first operation of a first semicircular sleeve and a second semicircular sleeve of a preferred embodiment in accordance with the present invention;

FIG. 6 is a schematic view illustrating a second operation of a first semicircular sleeve and a second semicircular sleeve of a preferred embodiment in accordance with the present invention; and

FIG. 7 is a schematic view illustrating a folding of a sunshade device of a preferred embodiment in accordance with the present invention.

### DETAILED DESCRIPTION OF THE INVENTION

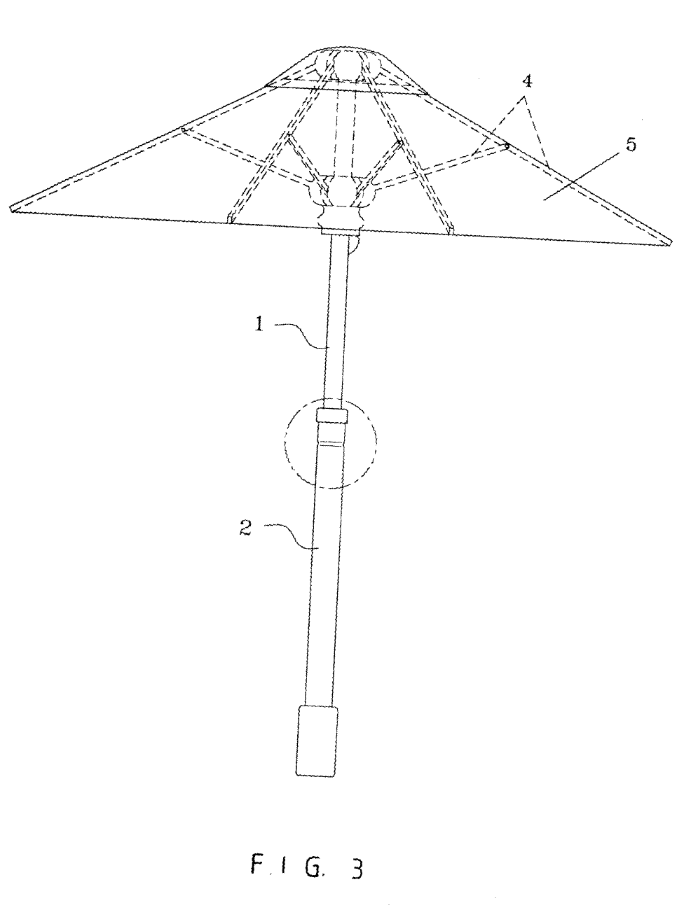

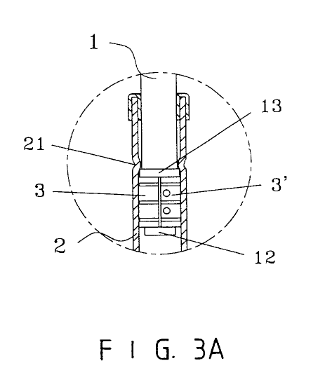

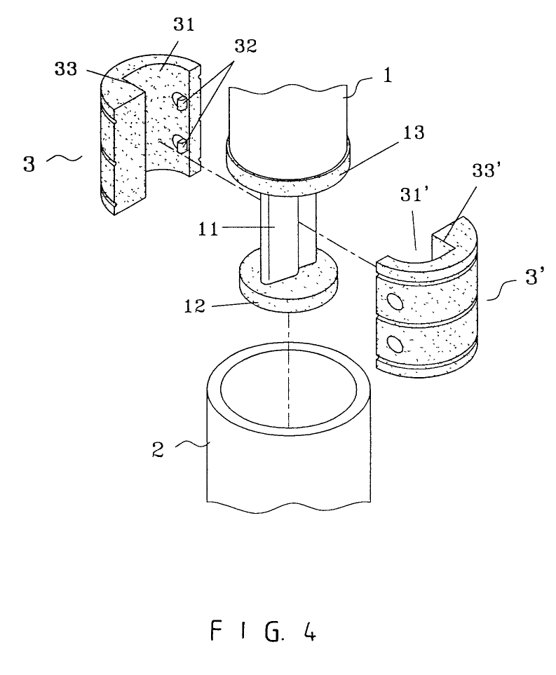

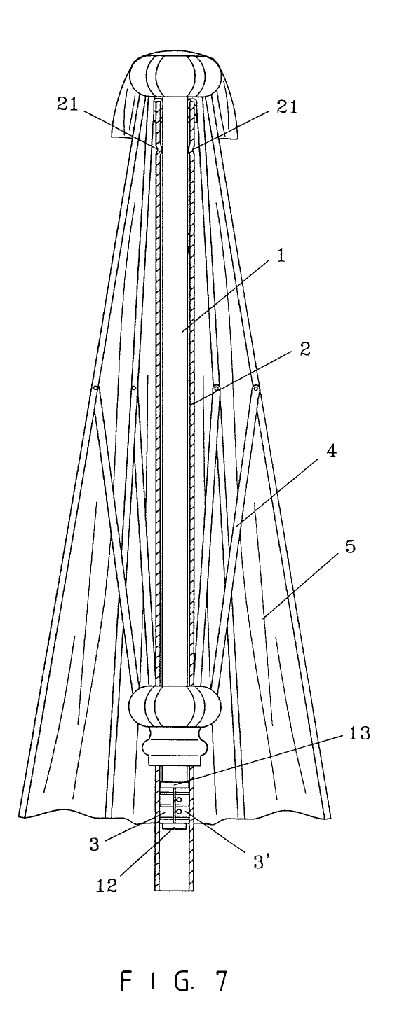

Referring to FIGS. 3 to 7, a sunshade device comprises a lower hollow shaft 2, an upper shaft 1 inserted in the lower hollow shaft 2, a plurality of stretchers 4 connected to the upper shaft 1, and a sunshade awning 5 disposed on the stretchers 4.

The lower hollow shaft 2 has a narrowed neck portion 21.

The upper shaft 1 has a lower end cover 13, a neck bar 11 disposed on a bottom of the lower end cover 13, and a base disk 12 disposed on a bottom of the neck bar 11.

A first semicircular sleeve 3 and a second semicircular sleeve 3′ are inserted in the lower hollow shaft 2.

The first semicircular sleeve 3 has a first interior 31, a pair of first protruded blocks 32, and a first confining portion 33.

The second semicircular sleeve 3′ has a second interior 31′, a pair of second protruded blocks 32′, and a second confining portion 33′.

The first semicircular sleeve 3 engages with the second semicircular sleeve 3′.

The first semicircular sleeve 3 and the second semicircular sleeve 3′ surround the neck bar 11.

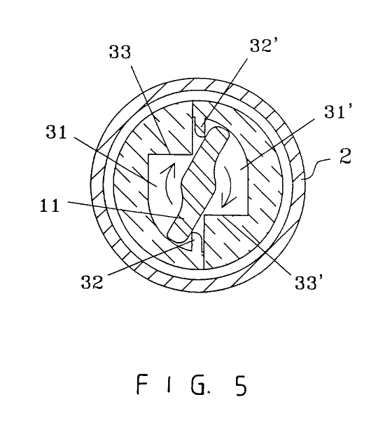

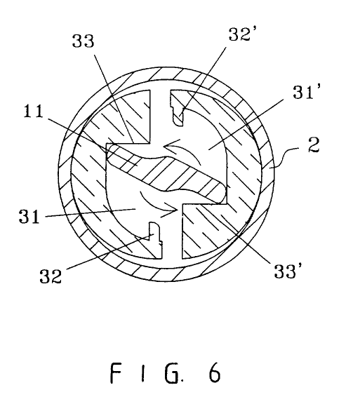

Referring to FIGS. 5 and 6, the neck bar 11 is rotated in the first interior 31 of the first semicircular sleeve 3 and the second interior 31′ of the second semicircular sleeve 3′.

The present invention is not limited to the above embodiments but various modification thereof may be made. Furthermore, various changes in form and detail may be made without departing from the scope of the present invention.

I claim:

1. A sunshade device comprises:
a lower hollow shaft,
an upper shaft inserted in the lower hollow shaft,
a plurality of stretchers connected to the upper shaft, and a sunshade awning disposed on the stretchers,
the lower hollow shaft has a narrowed neck portion.
the upper shaft having a lower end cover, a neck bar disposed on a bottom of the lower end cover, and a base disk disposed on a bottom of the neck bar,
a first semicircular sleeve and a second semicircular sleeve inserted in the lower hollow shaft,
the first semicircular sleeve having a first interior, a pair of first protruded blocks, and a first confining portion,
the second semicircular sleeve having a second interior, a pair of second protruded blocks, and a second confining portion,
the first semicircular sleeve engaging with the second semicircular sleeve,
the first semicircular sleeve and the second semicircular sleeve surrounding the neck bar, and
the neck bar rotated in the first interior of the first semicircular sleeve and the second interior of the second semicircular sleeve.
